(19) United States
(12) Patent Application Publication
(10) Pub. No.: US 2014/0101733 A1
(43) Pub. Date: Apr. 10, 2014

(54) SYSTEM AND METHOD FOR SECURE USER AUTHENTICATION WITH A SINGLE ACTION

(71) Applicant: Troy Jason Cain, Sayville, NY (US)

(72) Inventor: Troy Jason Cain, Sayville, NY (US)

(21) Appl. No.: 13/752,345

(22) Filed: Jan. 28, 2013

Related U.S. Application Data
(60) Provisional application No. 61/711,723, filed on Oct. 9, 2012.

(51) Int. Cl. G06F 21/31

(52) U.S. Cl. CPC G06F 21/31
USPC 726/5

(57) ABSTRACT

A system and method for securely authenticating a user provides the user the convenience of performing a single action to authenticate the user to an online business without any need for the user to enter, much less remember, any credentials specific to logging into the online business. An actionable item is provided to the user via a message sent to a messaging address that the user has provided when signing up with a backend system incorporating the disclosed authentication system. The actionable item, which incorporates authentication-related information for the user, is so formulated that a single action performed on the actionable item causes an authentication request to be sent to the backend system. The backend system, upon receiving the request, authenticates the user using the authentication-related information retrieved from the authentication request. Optionally, the user will be presented a destination page personally selected during the sign-up following a successful authentication.

### CROSS-REFERENCE TO RELATED APPLICATION

This application claims the benefit under 35 U.S.C. §119(e) of Provisional Patent Application No. 61/711,723, filed Oct. 9, 2012, the entire disclosure of which is hereby incorporated by reference.

### BACKGROUND

1. Technical Field

The present disclosure generally relates to a system and method for user authentication. The present disclosure more particularly relates to a system and method for secure user authentication with a single action.

2. Description of the Related Art

With the advent of Internet, online businesses have been growing rapidly. Most online businesses require a user to perform authentication to their respective underlying systems before granting access to the user. Also, different businesses may employ different policies for usernames and passwords used for authentication. So a username or a password that is acceptable to one business may not be acceptable to another business. As a result, a user who visits a variety of online businesses is forced to remember different sets of usernames and passwords, a task which, for many users, is a big inconvenience. On the other hand, enabling a user to perform a secure authentication without causing complications to a user is also desirable to online businesses, especially for small or mid-size businesses who try to wrestle customers away from big dominant businesses.

Therefore, there is a need for a system and method that allows an online business to enable a user to perform secure authentication without causing complications to the user.

### BRIEF SUMMARY

In one aspect, the present disclosure provides a system and method that lets a user sign-up with an online business for a single-action authentication with a user's messaging address (such as an e-mail address) and subsequently receives one or more messages (transmitted to the messaging address) in which there is an actionable authentication item. Upon performing a single action on the actionable authentication item, the user can be securely authenticated to the online business without inputting, and thus without any need of remembering, any personal authentication information (such as a username or a password).

In another aspect, the present disclosure provides a system and method of securely authenticating a user by not only leveraging the secure nature of an existing messaging system (such as an e-mail system) that a user regularly uses, but also authenticating a user based on authentication information (specific to the user) that are only available to an online business's internal system. With this aspect alone, it is difficult for a malicious hacker to break the disclosed authentication scheme since the hacker would have to not only defeat the security of the existing messaging system used to deliver the message containing the actionable item but also break into the internal system of an online business in order to get hold of the specific information used for authentication. Thus, the disclosed authentication scheme is stronger than conventional authentication schemes relying on user's inputting of the user's username and password. Additionally, the disclosed authentication removes the possibility of user inadvertently or unknowingly leaking the much-less-often-used authentication information for the online business.

In yet another aspect, the present disclosure provides an authentication system and method by incorporating there-into both an expiration scheme and an encryption scheme in which the encryption scheme is dependent on timing information used in the expiration scheme. With this aspect alone, it is difficult for a malicious hacker to break the disclosed authentication scheme since the hacker would have to defeat both the expiration scheme and the encryption scheme involved therein. Thus, the disclosed authentication scheme is stronger than a conventional authentication scheme relying on a user's inputting of the user's username and password.

In yet another aspect, the present disclosure provides a single-action authentication system and method that enables a user to be taken to a specific web page of the user's choice following a successful authentication, so that there is no need for the user to search for a desired page following a successful authentication.

In yet another aspect, the present disclosure provides a system and method of enabling an online business to use the single-action authentication system disclosed therein by using a plug-in scheme to seamlessly integrate the single-action authentication system into the online business's existing server system.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a block diagram illustrating a single-action authentication system, according to one or more embodiments of the present disclosure.

FIGS. 2A-B illustrate how a user may sign up with the presently disclosed single-action authentication system and subsequently receives an actionable item used for a single-action authentication in one or more messages transmitted to a messaging address that the user provided during sign-up, according to one or more embodiments of the present disclosure. More specifically, FIG. 2A is a flowchart exemplifying a user sign-up process, and FIG. 2B is an exemplary form that the presently disclosed system may present to the user for signing-up.

FIG. 3 is a flowchart illustrating an exemplary implementation of forming an actionable authentication item, according to one or more embodiments of the present disclosure.

FIG. 4 is an exemplary implementation of how the backend system authenticates a user upon receiving an authentication request triggered by a single action performed on an actionable authentication item, in accordance with one or more embodiments of the present disclosure.

FIG. 5 is a flowchart illustrating an exemplary implementation of how the backend system authenticates the user using authentication-related information retrieved from an authentication request triggered by a single action performed on an actionable authentication item, in accordance with one or more embodiments of the present disclosure.

FIG. 6 is flowchart illustrating how an online business can take advantage of the presently disclose single-action authentication system and method by installing a plug-in software package implementing the same single-action authentication system, in accordance with one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates similar or identical items, and similar elements can be provided similar names and reference numerals throughout the figures. If a reference numeral is once used to refer to a plurality of like elements, unless required otherwise by context, the reference numeral may refer to any, a subset of, or all of, the like elements in the figures bearing that reference numeral. The specific identifiers/names and reference numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof (e.g., “left side,” and etc.) should be construed to refer to the logical orientation as then described or as shown in the drawing figure under discussion. These relative terms are for convenience of description and are not intended to convey any limitation with regard to a particular orientation.

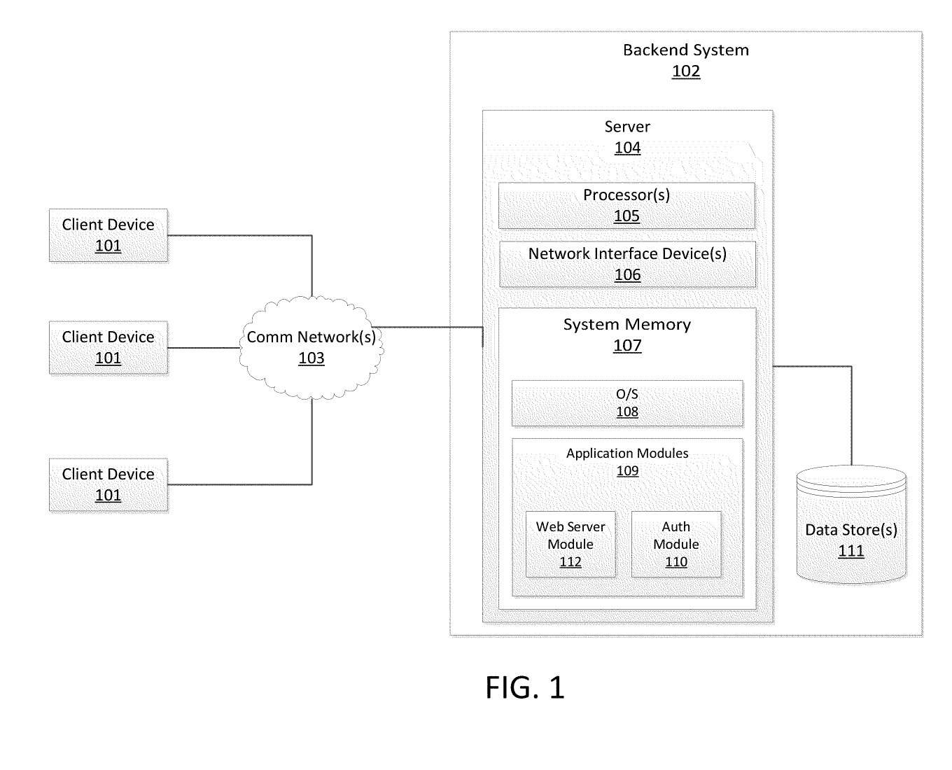

With reference now to the figures, and beginning with FIG. 1, there is depicted a block diagram illustrating a single-action authentication system in accordance with one or more embodiments of the present disclosure. Referring to FIG. 1, the single-action authentication system comprises client devices 101 and a backend system 102, which are communicatively coupled to each other via one or more communication networks 103, such as Internet, one or more cellular networks and one or more local area networks. Client devices 101, as shown in FIG. 1, can be any computing devices having networking capabilities, such as PDAs, smartphones, PCs, notebook computers and tablets. In particular, each client device 101 is equipped with one or more messaging programs—such as Microsoft Outlook, a web browser capable of accessing web-based emails (such as Gmail, Hotmail or Yahoo! Email), or programs capable of receiving text or multimedia messages.

Backend system 102 comprises server 104. As used herein, the term “server” refers to any of various types of computing devices, such as computer clusters, server pools, general-purpose personal computers, workstations, or laptops. Server 104 comprises, inter alia, one or more processors 105 (such as one or more microprocessors), one or more system memories 107, one or more network interface devices 106 (not shown), and etc. In one embodiment, one or more system memories 107 include operating system 108 and application modules 109. Application modules may include web server module 112 and authentication module 110.

Backend system 102 further comprises one or more data stores 111 (hereinafter referred to as “DS 111”) communicatively coupled to the one or more processors 105 of server 104. DS 111 may exist or be implemented in one or more of various forms, such as one or more relational or objective databases, one or more local or distributed file systems, one or more removable storages, one or more system caches, one or more system memories, or any combination thereof. In embodiment, DS 111 resides in server 104. In another embodiment, DS 111 resides external to server 104.

Application modules 108 may be implemented in different forms, such as executable programs, callable functions and routines, scripts that can be executed via running of one or more interpreter programs, services that may be invoked by standard or proprietary protocols, programmatic objects containing both data and functional modules, and etc. In particular, application modules may include web server module 112, which, e.g., receives online requests from client devices 101 and directs the user requests to other modules, a business logic module (not shown), which implements business logic of, e.g., an online business, and an authentication module 110, which contains programmatic code implementing authentication logic used to authenticate a user to backend system 102 before allowing the user to access the backend system 102.

In the present disclosure, the terms “module”, “application”, “application module”, “software”, “software program”, “software module”, “programmatic module”, “code”, “application code”, “programmatic code”, “object”, “programmatic object”, “script”, “routine”, “service routine”, “function”, “service”, and so on, when context allows, may be used interchangeably to refer to one or more sets of computer instructions adapted to perform, when executed by a processor, one or more specific functions (e.g. a microprocessor or a microcontroller).

As used herein, the term “online business” refers to any entity having online presence for furthering one or more objectives of the entity, regardless of the nature of the entity. Thus, in the context of the present disclosure, a for-profit or non-profit organization owning an online system, a commercial or non-commercial institution having a web site either through its own server or a third party's server, or an individual delegating a third-party service provider to publish the individual's articles online, can all be referred to as “online businesses.”

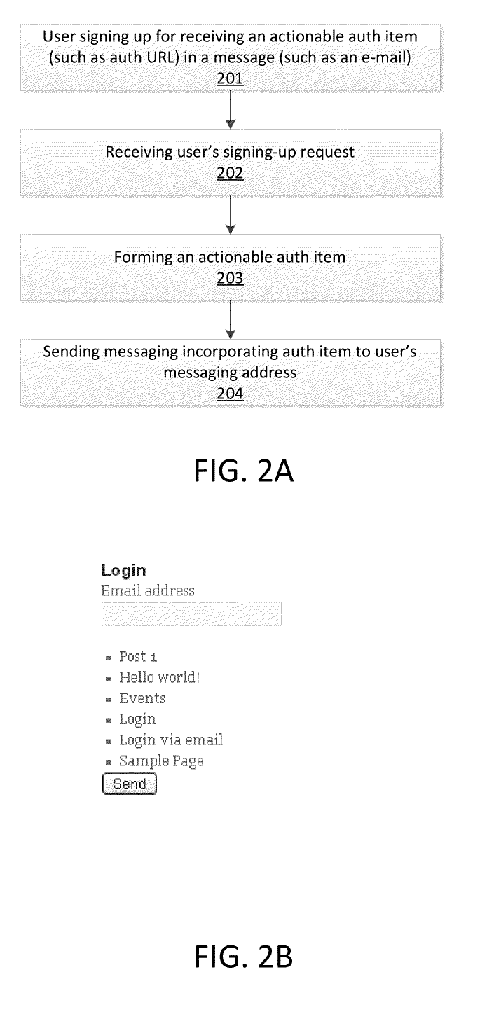

FIGS. 2A-B illustrate how a user may sign up with the presently disclosed single-action authentication system and subsequently receives an actionable item used for a single-action authentication in one or more messages transmitted to a messaging address that the user provided during sign-up, according to one or more embodiments of the present disclosure.

FIG. 2A is a flowchart exemplifying a user sign-up process. As used herein, the terms “block” and “step” may be used interchangeably to refer to a set of programmatic code adapted to perform one or more specific functions when executed by a processor. Referring to FIG. 2A, at step 201, a user is presented with a sign-up form, which is usually provided by an online business, for the user to sign-up with a presently disclosed single-action authentication system used by the online business. FIG. 2B shows an exemplary user sign-up form the backend system 102 may provide to the user for signing-up with backend system 102. On the exemplary form, a text input box is provided to let a user enter an e-mail address of the user. A “Send” button is provided to let the user perform the final submission. So if the user clicks the “Send” button after providing the user's e-mail address, an e-mail including an actionable item for single-action user authentication will be sent to the user's e-mail address. The user may then perform a single action on the actionable item to get the user authenticated to the online business. Following the authentication, the user may be presented a default web page of the host web site of the online business.

Optionally, a list of clickable links (hereinafter referred to as “destination link” or “destination links”) is provided in the sign-up form. Each of these links corresponds to a destination page that a user may select as the web page to which the user prefers to be taken following a successful authentication, Thus, if a user clicks one of these links after entering the user's e-mail address, the actionable item sent to the user's e-mail address is specifically formed to take the user to the destination page corresponding to the destination link which the user clicked (selected) during the sign-up process following a successful authentication.

At block 202, server 104 of the online business receives the user's sign-up request as a result of the user's clicking of the “Send” button or the user's clicking of one of the destination links.

At block 203, server 104, via, e.g. one or more of its application modules (such as authentication module 110), forms an actionable item (also referred to hereinafter as “authentication item”) such that when a single action is performed on the actionable item by the sign-up user, the user will be authenticated to backend system 102. Typically, the authentication item is an actionable graphical user interface (“GUI”) element.

As a first example, the authentication item is a clickable URL hyperlink (which is also referred to as “link”), the clicking of which causes the user to be authenticated to backend system 102 (via server 104). Thus, with a single action (namely, the clicking of the URL link), the user is authenticated to backend system 102 (via server 104).

As a second example, the authentication item is a clickable button formed as part of an underlying HTML form, with the clicking of the button causing the submission of the underlying HTMTL form to backend system 102. The underlying HTML form is so formed that the submission of the form causes the user to be authenticated to backend system 102. Thus, with a single action (namely, the clicking of the button), the user is authenticated to backend system 102.

As a third example, the authentication item is GUI widget formed as part of an underlying HTML form. Particularly, the GUI widget may include a thumbwheel and may be programmed (e.g. using Javascript) to allow a user to slide the thumbwheel from one point to another point so as to materialize the submission of the underlying HTML form. The underlying HTML form is so designed that the submission of the form causes the user to be authenticated to backend system 102. Thus, with a single action (namely, the sliding of the thumbwheel from one point to another point), the user is authenticated to backend system 102.

As a skilled artisan readily appreciates, the actionable authentication item can be implemented in various forms without departing from the scope and spirit of the present disclosure. Thus, examples of an actionable authentication item applicable to the present disclosure are not limited to the three examples described above.

Therefore, as used herein, the terms “actionable authentication item”, “authentication item”, and “actionable item”, in instances where an actionable authentication item is an integral part of an authentication entity incorporating the actionable item, such as an HTML form noted above in connection with the second and third examples, does not necessarily refer to the actionable authentication item alone, but instead can refer to actionable authentication item, or the authentication entity incorporating the actionable authentication item, or both the actionable authentication item and the authentication entity, as context requires.

At block 204, server 104 creates a message which includes, among other things, the formed actionable authentication item, and sends the message to the messaging address (which, in this case, is the e-mail address) which the user provided during the sign-up process. In particular, the message is created in such a form that allows the authentication item to be rendered visible and actionable.

For example, the message may be created in HTML format such that the authentication item can be rendered as an actionable GUI element. If there is any data associated with the actionable authentication item—e.g. form data defining an underlying HTML form of which the actionable authentication item is an integral part, as applicable to the second example or the third example described above—the associated data are also included in the message in either a visible form or a non-visible form. That is, in a case where an authentication triggered by the single action performed on the authentication item can only be materialized by the presence of the authentication entity incorporating the actionable authentication item, the authentication entity (such as the HTML form), in its entirety, may be included in the message in a suitable format that allows the authentication to materialize with a single action performed on the authentication item.

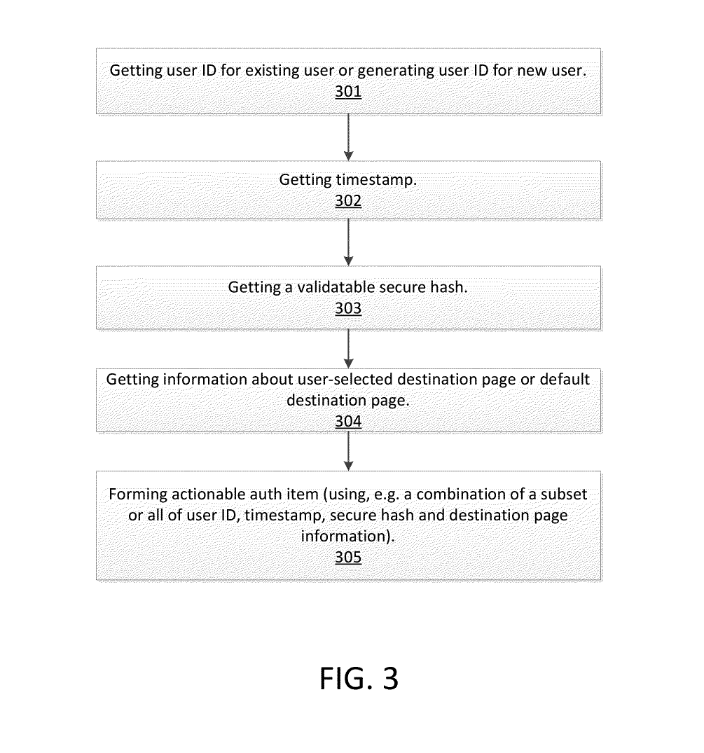

FIG. 3 is a flowchart illustrating an exemplary implementation of block 203—namely, forming an actionable authentication item—in accordance with one or more embodiments of the present disclosure.

In operation, at block 301, server 104 either retrieves a user ID for an existing user or generates a user ID for a new user. As will be disclosed in more detail below, block 203 not only will be invoked as a result of a new user signing up with the single action authentication system, but also will be invoked resulting from, e.g., an existing user's single action performed on an expired authentication item. Thus, the user ID for an existing user, e.g., may be retrieved from DS 111 where user authentication data is stored. A new user ID for a user who just signed-up may be generated using known ID-generation techniques. A user ID is assigned used internally by the backend system 102 to identify a particular user. So, there is no need for a user to know or remember the user ID for the authentication purpose.

At block 302, the timestamp for the contemporaneous time (at which step 203 is carried out) is obtained. The timestamp will later be used during a user authentication process (as triggered by a single action performed on an authentication item) to decide whether the actionable authentication item has been expired and thus is no longer valid. Blocks 301 and 302 can be performed without any particular order, or may be even performed simultaneously.

At block 303, a validatable secure hash is calculated. In one embodiment, as exemplified in code snippet 1, the secure hash is calculated using MD5 encryption scheme based on the user ID acquired at block 301, the timestamp obtained at block 302, and a third parameter which code snippet 1 refers to as “user_password”. A skilled artisan readily appreciates that this “user_password”, despite its name given by code snippet 1, is a security parameter, which is a piece of security information internally generated for the user (identified by the user ID) and stored (e.g. in DS 111) in the backend system 102 as a secret “seed” for the aforementioned MD5 encryption scheme (which is used to generate the secure hash). With the manner in which the secure hash is generated, the secure hash can be later validated during a user authentication process (triggered by a single action performed on the actionable authentication item which the current block 303 is performed to form).

Code Snippet 1

/* before calling md5, $user_id contains internally generated or stored ID
for the user, $timpstamp contains the timestamp of the current time (at
which an authentication URL is being formed), and $user_password
contains internally generated or stored password for the user */
$hash = md5($user_id. $timestamp. $user_password);

As a skilled artisan readily appreciates, various encryption schemes other than MD5 may be used to generate a secure hash—namely, an alphanumerical string used for the validation purpose—without departing from the spirit and scope of the present disclosure. For example, another encryption scheme may be used to generate a secure hash, as long as the generated secure hash can be later validated with the same or a corresponding encryption scheme using a set of parameters (such as a subset or all of the user ID, the timestamp, and the internally generated and stored “user_password”) known to a system performing the validation (such as backend system 102).

At block 304, information regarding the destination page to be presented following a successful user authentication is obtained. If the user selects a particular page as the designation page during the sign-up process illustrated in FIGS. 2A-B, then the selected page will be set as the destination page. Otherwise, a default page will be set as the destination page. The destination page can be represented in various forms. For example, the destination page may be represented or indicated by an alphanumerical value identifiable by backend system 102. If the sign-up form exemplified in FIG. 2B does not display any destination links for a user to select, then block 304 is not needed, since the default page will be the destination page.

At block 305, a subset or all of the information acquired at blocks 301-304 is combined to form an actionable authentication item for the user. In one embodiment, if the authentication item is a clickable URL hyperlink (as is the case for the first example disclosed above in connection with block 203), the URL hyperlink, as exemplified by code snippet 2, can be formed by first creating a base URL, and then adding to the base URL the user id, the timestamp, the secure hash, and the information regarding the destination page (as obtained in earlier steps) as authentication-related information in a format or manner understood by server 104. In particular, the URL hyperlink is formed in such a manner that server 104 (via, e.g., authentication module 110), upon receiving an online request triggered by the clicking of the URL link, understands that online request is a request for a user authentication, and knows how to retrieve from, e.g., authentication-related information—such as the user id, the timestamp, the secure hash, and the information regarding the destination page—from the online request. Thus, the clicking of the URL link causes an online request for user authentication to be sent to server 104, which may then authenticate the user based on the authentication-related information incorporated into the online request.

Code Snippet 2

/* kml_base_URL is a constant string containing base URL for host server system.
$login_url =
kml_base_URL.“kmllogin.php?user=$user_id&tamp=$timestamp&hash=$hash&destination=$destinition”;

As a skilled artisan readily appreciates, other various forms of the actionable authentication item, such as the clickable button or the GUI widget illustrated and exemplified in connection with step 203, may be similarly formed by creating an authentication entity (e.g. an HTML form) and incorporating into the authentication entity authentication-related information (such as the user id, the timestamp, the secure hash, and the information regarding the destination page, as obtained in blocks 301-305) in such a format or manner that a single action performed on the authentication item results in (or, in other words, triggers) an authentication request incorporating the authentication-related information being sent to server 104. The formed authentication entity is then delivered to the user's messaging address at step 204 as part of a message (such as an e-mail or text message).

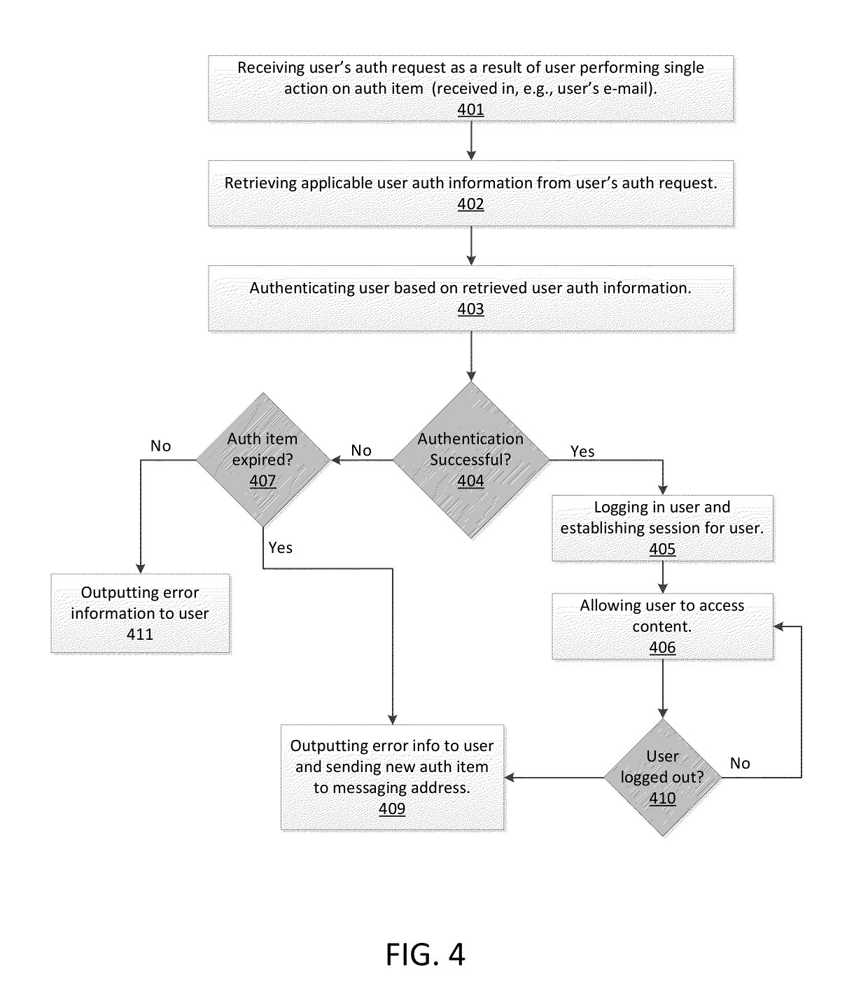

FIG. 4 is flowchart illustrating an exemplary implementation of how backend system 102 authenticates a user upon receiving an authentication request triggered by a single action performed on an actionable authentication item (as illustrated and exemplified in FIGS. 2-3), in accordance with one or more embodiments of the present disclosure.

At block 401, server 104 of backend system 102 receives a user's authentication request triggered by a single action performed on an actionable authentication item received in a message (such as an e-mail) sent to a messaging address (such as an e-mail address) of the user earlier.

At block 402, server 104 (via, e.g. authentication module 110) retrieves authentication-related information included in the received authentication request. As noted above in connection with blocks 301-305, authentication-related information may include a user id, a timestamp, a secure hash, and/or information regarding a destination page.

At block 403, server 104 authenticates the user based on authentication-related information retrieved at block 402.

At decision 404, server 104 checks whether the authentication is successful. If the authentication is successful, decision 404 proceeds to block 405 where server 104 logs in the user, and subsequently to step 406, where server 104 establishes a session for the user to access, e.g., contents or services (such as online shopping, online gaming, and etc.) provided by backend system 102 (on behalf the online business operating backend system 102). The user may continue to access the contents or services of backend system 102 until the user is logged out. If it is detected at decision 410 that the user is logged out, in one embodiment, a message including a new actionable authentication item may be sent to the user's messaging address.

If at decision 404, the authentication is found to be unsuccessful, decision 404 proceeds to decision 407 where server 104 checks whether the authentication item triggering the user authentication is expired. If the authentication item is found to be expired, server 104, at block 409, informs the user of the expiration of the authentication item via, e.g. an output page sent to the user's client device 101. Otherwise, it may be decided that the authentication failure is due to one or more reasons other than the expiration of the authentication item. At block 411, server 104 informs the user of the authentication failure via, e.g. an output page sent to the user's client device 101.

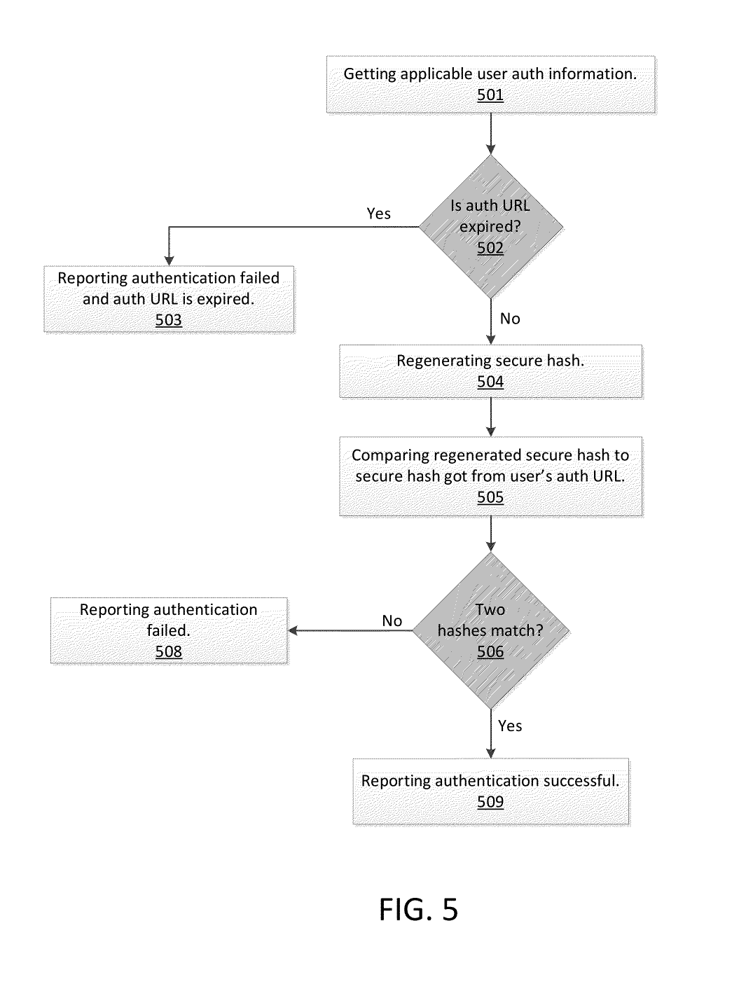

FIG. 5 is a flowchart illustrating an exemplary implementation of block 403 (namely, authenticating the user based on retrieved authentication-related information), in accordance with one or more embodiments of the present disclosure.

At block 501, server 104 acquires applicable authentication-related information (upon which the authentication request is based), such as a user id, a timestamp, a secure hash, and information regarding a destination page. The acquired authentication-related information was retrieved at block 402 from the user's authentication request triggered by a single action performed on an actionable authentication item.

At decision 502, server 104 checks the timestamp acquired at block 501 against the current time to decide whether the triggering authentication item is expired. The acquired timestamp, which was retrieved from the authentication request, is supposed to indicate the time at which the triggering authentication item was formed (and then contemporaneously sent to the user's messaging address via a message). In determining whether the triggering authentication item is expired or not, server 104 checks the length between the current time and the time indicated by the acquired timestamp against a pre-set threshold time length (e.g., 24 hours). If the former exceeds the latter, server 104 determines that the triggering authentication item is expired, and as a result, the current user authentication is an invalid one and thus is deemed failed. Otherwise, server 104 determines that the triggering authentication item is not expired, and as a result, the current user authentication continues.

This expiration scheme is aimed to prevent or reduce abuses in connection with performing single-actions on actionable authentication items for authentication purposes. By first checking whether the received timestamp indicates an expired authentication item, server 104 may quickly weed out invalid triggering authentication items without performing the relatively more time-consuming and resource-intensive validation on the retrieved secure hash.

Additionally, the expiration scheme also helps to strengthen the single-action authentication system disclosed therein. First, with the timestamp used in the expiration scheme also being used in the encryption for forming an actionable authentication item, it makes a hacker futile to just tamper the timestamp incorporated into an actionable authentication item in an attempt to defeat the expiration scheme. Second, the sheer existence of the expiration scheme as part of the disclosed authentication scheme forces a hacker to expend resources otherwise not required in order to “keep” the hacking effort “up-to-date”, thereby effectively deterring the hacker from hacking into the disclosed authentication system.

If at decision 502, the triggering authentication item is found to be expired, step 503 is performed where expiration of the triggering authentication item is reported (as used in decision 407) as the reason for authentication failure. Otherwise, decision 502 proceeds to step 504 where a secure hash is regenerated for the validation purpose.

In one embodiment, to regenerate a secure hash, server 104 re-performs sub-steps previously performed at block 303 to generate the secure hash used to form the triggering authentication item. In re-performing these sub-steps, server 104 assumes that the user id and the timestamp acquired at block 501—which are retrieved from the triggered authentication request and supposed to be the respective user id and timestamp used at block 303—were used in the encryption scheme used at block 303. Additionally, server 104 retrieves the “user_password” parameter internally stored (for the user seeking current authentication), which was also used in the encryption scheme at block 303. The encryption scheme is subsequently re-performed to regenerate a secure hash.

At block 505, the regenerated secure hash is compared with the secure hash acquired at block 501—which is retrieved from the triggered authentication request and supposed to be the secure hash previously generated at block 303 and used to form the triggering authentication item.

At decision 506, if the two secure hashes match, the secure hash retrieved from the triggered authentication request is proved to be valid. This in turn indicates that the online authentication request indeed originates from an actionable authentication item sent to the authentic user's messaging address, and does not originate from an artificially created actionable authentication item aimed to break into an authentic user's account with the online business (operating backend system 102). This is because it is difficult for a hacker to regenerate a matching secure hash. Particularly, in order to do so, the hacker has to know not only information about the user id and the timestamp used for encryption, but also the exact encryption scheme and the internally stored “user_password” information for the authentic user, both of which are internal to backend system 102 and not available to an outsider.

Additionally, it is reasonable to assume that only the authentic user can access the messaging address (e.g. an e-mail address) via which the actionable authentication item is delivered to the user. This is because it is reasonable to assume that a reasonable user usually chooses and sticks with a messaging system (e.g. an e-mail system) known and tested to be secure for a messaging address of the user's own for daily messages. Thus, the match between the two hashes indicates that it is the authentic user who performed a single action on the authentication item which triggers the authentication request. Therefore, decision 506 proceeds to block 508 where a successful authentication is reported to server 104.

If the two secure hashes do not match, the secure hash retrieved from the triggered authentication request is proved to be invalid. Similar to the reasoning stated above, this in turn indicates that the received authentication request could be an artificially created one originating from a malicious hacker trying to illicitly break into a user's account with the online business. Thus, decision 506 proceeds to block 507 where a failed authentication is reported to server 104.

As a skilled artisan appreciates, since there can be various ways to generate a secure hash used to form an actionable authentication item, similarly, there may also be various corresponding ways to validate a secure hash retrieved from an online authentication request in connection with block 401. Thus, validating a secure hash retrieved from an online authentication request using techniques different from what has been described above does not depart from the scope and spirit of the present disclosure.

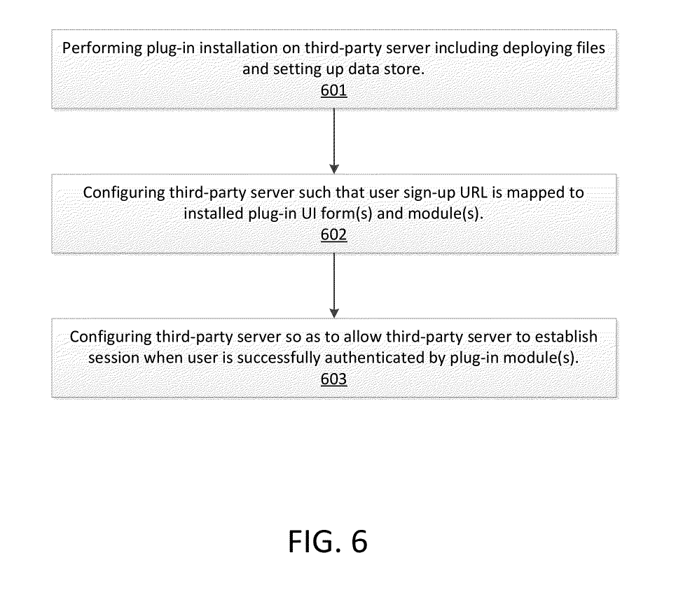

FIG. 6 is flowchart illustrating how a third party online business can take advantage of the single-action authentication system and method disclosed therein by installing a plug-in software package implementing the same single-action authentication system and method, in accordance with one or more embodiments of the present disclosure.

At block 601, a plug-in software package implementing the single-action authentication system and method disclosed therein is installed on a third party online business's backend system 102 (including server 102 and DS 111). The plug-in software package may include an installation script which an online business can execute to properly deploy relevant files on server 104 and set up DS 111.

At block 602, optional or necessary configurations are performed on the backend system 102. For example, server 104 may be configured such that a URL for user sign-up is mapped to one or more plug-in GUI forms for user sign-up installed on the server at block 601. Additionally, plug-in GUI forms for user sign-up may be configured to customize the destination links illustrated in FIG. 2B so as to make the destination links correspond to respective destination web pages of the online business.

At block 103, server 104 may be configured such that a successful authentication of a user results in server 102 establishing a session for the user so that the user can, e.g., access contents of backend system 102.

Advantages of the single-action authentication system and method disclosed therein are numerous. First, with the single-action authentication system installed and properly configured on a backend system of an online business, the complications involved in user's logging into the online business are substantially reduced as the user only needs to perform one single action to trigger an authentication request without any need to look for and then input credentials, such as the use's username and password.

Second, with the single-action authentication system installed or deployed for the online businesses, the user, as long as having access to one secure messaging address, no longer needs to know or remember one or more authentication credentials (such as username and password) for each and every online business that the user occasionally desires to access. In other words, with the single-action authentication system installed on online businesses, by remembering only one pair of username and password for accessing a regularly-used secure messaging address that the user personally trusts, the user can gain access to potentially hundreds of online businesses without ever needing to remember or input any authentication credentials.

Third, by leveraging the security of a messaging system which the user knows, tests, and trusts to be secure as well as authenticating a user based on information internal to an online business, the single-action authentication scheme is substantially more secure than conventional authentication systems relying solely on user-provided authentication credentials.

Fourth, by incorporating into its validation process both an expiration scheme and an encryption scheme dependent on timing information used in the expiration scheme, the single-action authentication scheme is substantially more secure than conventional authentication systems.

Fifth, by letting a user to choose a destination page following a user authentication, the user can directly go to a desired page following a user authentication without being forced to face an undesired default page and search for a link leading to the desired page.

The blocks and steps described in connection with the embodiments disclosed herein and within the scope of the present disclosure can be embodied in one or more software modules executed by a processor. The one or more software modules can reside in one or more computer readable media. Such computer readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium.

As a skilled artisan readily appreciates, although the present disclosure uses the term “single-action” to describe the disclosed authentication system, the term is merely used for convenience to refer to an exemplary optimal scenario where a user can authenticate himself or herself into a system with one action as a result of the novel and inventive components, steps, structures, configurations and methodologies disclosed therein. Thus, the term “single-action” may only be viewed as used for the purpose of illustration and must not be viewed as used for the purpose of limitation. In other words, an authentication system using components, steps and methodologies similar to what have been disclosed in the present disclosure while having a user perform multiple actions, which include one or more toke actions, one or more extra solution actions, or one or more post solution actions, to trigger or materialize an authentication does not depart from the spirit and scope of the present disclosure.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

What is claimed is:

1. A method of authenticating a user to a backend system operated by an online business, the method comprising the steps of:
receiving, from the user, a messaging address of the user;
sending a message to the messaging address, the message including an actionable item adapted to contain authentication-related information and cause, when an action is performed on the actionable item, an authentication request for authenticating the user to be sent to the backend system with the authentication request including the authentication-related information; and
authenticating the user, upon receiving the authentication request, using the authentication-related information retrieved from the authentication request.

2. The method of claim 1, wherein the messaging address is an e-mail address of the user.

3. The method of claim 1, wherein the actionable item is a clickable URL hyperlink directed to a server of the backend system.

4. The method of claim 1, wherein the authentication-related information includes identification information generated stored in the backend system for identifying the user, timestamp information indicating a timestamp, and a first hash generated from the identification information, the timestamp information, and a security parameter internally generated for the user and internally stored in the backend system.

5. The method of claim 4, wherein authenticating the user further comprises verifying whether the actionable item is expired based on the timestamp information retrieved from the authentication request.

6. The method of claim 4, wherein authenticating the user further comprises regenerating a second hash using the identification information and the timestamp information retrieved from the authentication request as well as the security parameter retrieved from the backend system based on the retrieved identification information, and comparing the second hash with the first hash retrieved from the authentication request.

7. The method of claim 1, further comprising a step of receiving, from the user, information regarding a destination web page and a step of presenting the user the destination web page in response to a successful authentication of the user.

8. A system for authenticating a user, the system comprising:
a server having a processor and a system memory, said system memory containing a plurality of application modules adapted to perform, when executed by the processor, the steps comprising:
receiving, from the user, a messaging address of the user;
sending a message to the messaging address, the message including an actionable item adapted to contain authentication-related information and cause, when an action is performed on the actionable item, an authentication request for authenticating the user to be sent to the server with the authentication request including the authentication-related information; and
authenticating the user, upon receiving the authentication request, using the authentication-related information retrieved from the authentication request; and
a data store communicatively coupled to processor of the server and retrievably storing information associated with authenticating the user.

9. The system of claim 8, wherein the data store resides in the server.

10. The system of claim 8, wherein the messaging address is an e-mail address of the user.

11. The system of claim 8, wherein the actionable item is a clickable URL hyperlink directed to the server.

12. The system of claim 8, wherein the authentication-related information includes identification information generated stored in the data store for identifying the user, timestamp information indicating a timestamp, and a first hash generated from the identification information, the timestamp information, and a security parameter internally generated for the user and internally stored in the data store.

13. The system of claim 12, wherein authenticating the user further comprises verifying whether the actionable item is expired based on the timestamp information retrieved from the authentication request.

14. The system of claim 12, wherein authenticating the user further comprises regenerating a second hash using the identification information and the timestamp information retrieved from the authentication request as well as the security parameter retrieved from the data store based on the identification information, and comparing the second hash with the first hash retrieved from the authentication request.

15. The system of claim 8, wherein the steps performed by the plurality of application modules further comprises a step of receiving, from the user, information regarding a destination web page and a step of presenting the user the destination web page in response to a successful authentication of the user.

16. A computer readable medium carrying a set of instructions adapted to perform, when executed by processor, a set of steps comprising:
receiving, from the user, a messaging address of the user;
sending a message to the messaging address, the message including an actionable item adapted to contain authentication-related information and cause, when an action is performed on the actionable item, an authentication request for authenticating the user to be sent to a backend system with the authentication request including the authentication-related information; and
authenticating the user, upon receiving the authentication request, using the authentication-related information retrieved from the authentication request.

17. The computer readable medium of claim 16, wherein the messaging address is an e-mail address of the user.

18. The computer readable medium of claim 16, wherein the actionable item is a clickable URL hyperlink directed to a server of the backend system.

19. The computer readable medium of claim 16, the set of steps further comprises a step of receiving, from the user, information regarding a destination web page and a step of presenting the user the destination web page in response to a successful authentication of the user.
